(19) United States
(12) Patent Application Publication
(10) Pub. No.: US 2009/0133054 A1
(43) Pub. Date: May 21, 2009

(54) PRESENTATION OF AUXILIARY CONTENT VIA A CONTENT PRESENTATION DEVICE

(76) Inventors: Matthew Thomas Boggie, New York, NY (US); John Carl Anderson, Oak Hill, VA (US); Michael R. Bontempi, Ramsey, NJ (US)

Correspondence Address: Vedder Price PC, 222 NORTH LASALLE STREET, CHICAGO, IL, 60601, US

(21) Appl. No.: 11/941,655

(22) Filed: Nov. 16, 2007

(51) Int. Cl. H04N 7/10

(52) U.S. Cl. 725/32

(57) ABSTRACT

Auxiliary content not associated with programming content is provided to a content presentation device by at least one content provider. Similarly, programming content comprising detectable indicia is likewise provided by at least one content provider to the content presentation device. Prior to or during output of the programming content to a user, the content presentation device detects at least one detectable indicia in the programming content and inserts at least a portion of the previously received auxiliary content into the programming content. The auxiliary content may be filtered according to user information and selected for insertion into the programming content based on insertion criteria. Both the auxiliary and programming content may be provided by a single content provider or each may be provided by a different content provider. Because the content presentation device handles insertion of auxiliary content into programming content, more targeted presentation of auxiliary content is possible.

### FIELD OF THE INVENTION

The instant disclosure relates generally to the presentation of auxiliary content and, in particular, to presentation of such auxiliary content as mediated by a content presentation device.

### BACKGROUND OF THE INVENTION

In the realm of mass communications, it is well known for content providers to include a variety of auxiliary content in the programming content they normally provide. For example, in the case of television programming content provided by a service provider (e.g., a cable or satellite television carrier, an internet protocol television (IPTV) carrier, an Internet Television carrier, etc.) the auxiliary content (e.g., advertising or public service content) is inserted into the television programming content and distributed by a broadcaster's playout process and/or by the end user's local network provider. An example of this is illustrated in FIG. 1.

FIG. 1 illustrates a content stream 100 that may be provided to a typical user's content presentation device having auxiliary content 104 dispersed therein. As known in the art, the auxiliary content 104 may be provided within the content stream 100 during predetermined time slots 105, 106. During playout of the content stream 100, each of the time slots 105, 106 is typically delimited by detectable indicators 107, 109. For example, in a cable television system, the detectable indicators 107, 109 may comprise so called dual-tone, multi-frequency (DTMF) tones or digital messages. In such systems, the detection of the first indicator 107, using known techniques, allows the broadcaster/network provider to insert the auxiliary content (determined, often, by the programming content originator or the local network provider) into the programming content. While the technique illustrated in FIG. 1 has worked well, it is difficult, if not impossible, to tailor the delivery of targeted auxiliary content to specific users.

Newer approaches have been suggested to allow local distributors greater control over insertion of auxiliary content. An example of this is illustrated in FIG. 2 where a content stream 100 is provided by a local network provider along with a simultaneous auxiliary content stream 200 to one or more content presentation devices. Typically, the content stream 100 and the auxiliary content stream 200 occupy different selectable channels within the local network. Detection of the detectable indicators 107, 109 causes the content presentation device (i.e., a cable set-top box) to force a channel change from the content stream 100 to the auxiliary content stream 200. Based on this channel change, the auxiliary content present in the auxiliary content stream 200 is thereby presented to the user of the content presentation device. However, this method is largely untested at this time and is difficult to determine what ramifications, if any, such technique will have on the customer experience. For example, forcing channel changes at the content presentation device may interrupt or cause malfunction of other services, such as interactive programming guide behavior, “last” button functionality and digital video recorder operation. Additionally, it remains a challenge to have the timing of the auxiliary content stream 200 precisely correspond to the normal timing of the content stream 100.

Accordingly, conventional techniques suffer from many limitations and inadequacies.

### SUMMARY OF THE INVENTION

The instant disclosure describes techniques for inserting auxiliary content in programming content in a manner as to enable the targeted provision of such auxiliary content. In particular, auxiliary content not associated with programming content is provided to a content presentation device by at least one content provider. Similarly, programming content comprising detectable indicia is likewise provided by at least one content provider to the content presentation device. Prior to or during output of the programming content to a user, the content presentation device detects at least one detectable indicia in the programming content and inserts at least a portion of the previously received auxiliary content into the programming content. The auxiliary content may be filtered according to user information provided to the content presentation device and may be selected for insertion into the programming content based on insertion criteria. Both the auxiliary content and the programming content may be provided by a single content provider or each may be provided by a different content provider. Because the content presentation device handles the task of inserting auxiliary content into programming content, more targeted presentation of auxiliary content is possible.

### BRIEF DESCRIPTION OF THE DRAWINGS

The features described in this disclosure are set forth with particularity in the appended claims. These features and attendant advantages will become apparent from consideration of the following detailed description, taken in conjunction with the accompanying drawings. One or more embodiments are now described, by way of example only, with reference to the accompanying drawings wherein like reference numerals represent like elements and in which:

FIGS. 1 and 2 illustrate prior art techniques for the provision of auxiliary content in content streams;

FIG. 3 is a schematic illustration of a technique for inserting auxiliary content into content streams in accordance with an embodiment described herein;

FIG. 4 illustrates a block diagram of a communication system in accordance with one or more embodiments described herein;

FIG. 5 is a schematic block diagram illustrating a content presentation device in greater detail;

FIG. 6 is a schematic block diagram of a content provider illustrated in greater detail;

FIG. 7 is a block diagram illustrating operation of a content presentation device in accordance with an embodiment described herein; and

FIG. 8 is a flowchart illustrating operation of a content provider in accordance with an embodiment described herein.

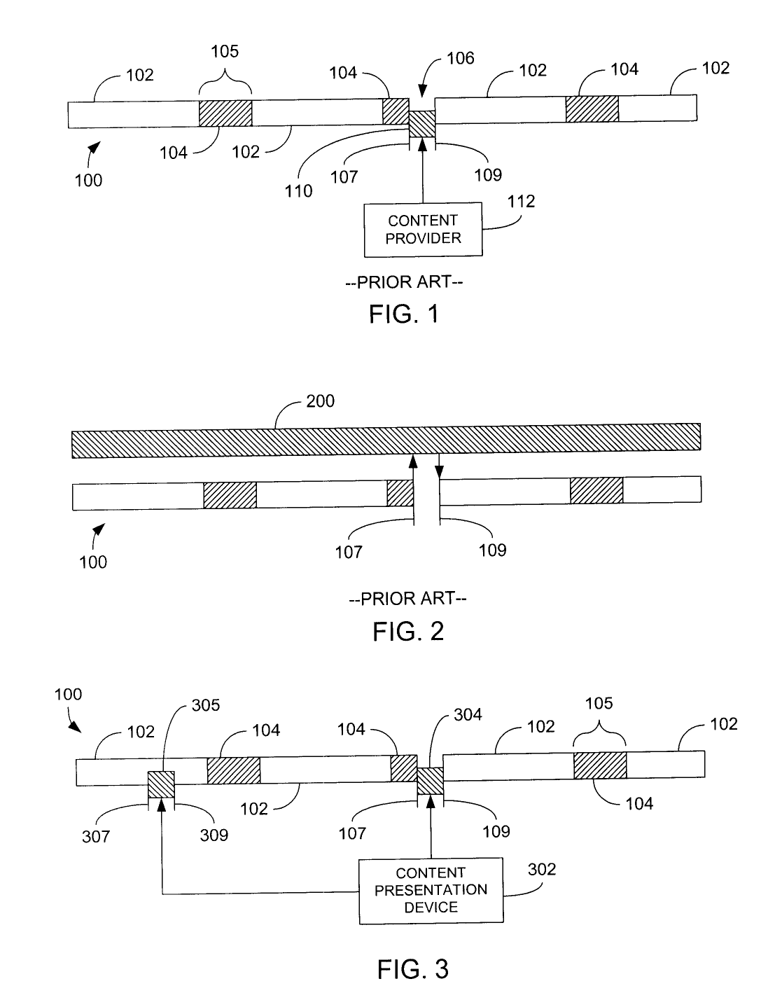

### DETAILED DESCRIPTION OF THE PRESENT EMBODIMENTS

FIG. 3 illustrates a technique for inserting auxiliary content into programming content. In particular, a content presentation device 302 receives auxiliary content 301 from one or more content providers (as described below). Based on detection of indicia 107, 307, 309 in the programming content by the content presentation device, at least a portion 304, 305 of the auxiliary content 301 is inserted into a content stream 100. As used herein, a content presentation device 302 comprises any device, whether used solely or in conjunction with other devices, to mediate playback of programming content 102 and/or auxiliary content 301 at the end-delivery point. For example, the content presentation device 302 may comprise a cable set-top box, a desktop or laptop computer and corresponding display, a portable device such as a cellular telephone or personal digital assistant, or any other similar or networked device (e.g. a refrigerator with embedded screen). Generally, the content presentation device 302 comprises a sufficient amount of available storage (e.g., around 2-4 GB) for the auxiliary content. As a result, targeted auxiliary content may be provided to and stored in the content presentation device at virtually any time without any particular association with programming content. For example, targeted auxiliary content may be delivered to the content presentation device (e.g., a set-top box) during software upgrades/updates, electronic program guide updates, or other updates/upgrades. These updates or upgrades may occur when the content presentation device is not in use or in the background when the device is in use.

As shown, the content presentation device 302 is capable of detecting the one or more detectable indicators 107, 109, 307, 309 and inserting the auxiliary content 304, 305 within the content stream 100. Devices and techniques for inserting auxiliary content into a content stream are well known in the art and may be readily incorporated into content presentation devices 302 described herein. For example, the Terayon Ad Carousel, Seachange Spot System or video on demand (VOD) AdPulse system may be employed for this purpose. Note that the content stream 100 may include auxiliary content 104 at the time the programming content is received by the content presentation device 302, in addition to “slots” in which the auxiliary content 304 may be inserted. In an embodiment, each inserted portion of the auxiliary content 304 replaces the programming content 102 or auxiliary content 104 for the duration of that portion of auxiliary content 304 (optimally equivalent to the length of the time slot in which it is inserted). Alternatively, the auxiliary content 305 may be presented in addition to, rather than replacing, the programming content 102. For example, the auxiliary content 305 may comprise an audio or visual overlay (e.g., at the top or bottom of the display or in the side bars or other portions of the display) that is presented in addition to, but does not replace, the programming content 102.

As used herein, programming content comprises the primary or main content (regardless of its encoding format, the channel(s) used to deliver it to a content presentation device, etc.) provided by a content provider for consumption by the end users. Examples of programming content include, but are not limited to, broadcast or cable television programs, radio or satellite programs, multimedia downloads such as audio and/or video files, executable games, etc. In a similar vein, auxiliary content may comprise virtually any type of secondary or complementary material in a wide variety of media formats intended, ultimately, for presentation to one or more users of a content presentation device. For example, the auxiliary content may comprise commercials of the type normally seen on network television, public service announcements, interactive offers, service notices, etc. The auxiliary content may further comprise materials that are complementary to the particular programming content that is provided to the content presentation device 404, e.g., sports scoreboard information, critical commentary, weather or news bulletins, or related promotional content. In one embodiment, the auxiliary content can be authored for presentation to a specific set of users meeting predefined criteria or even specific individual users.

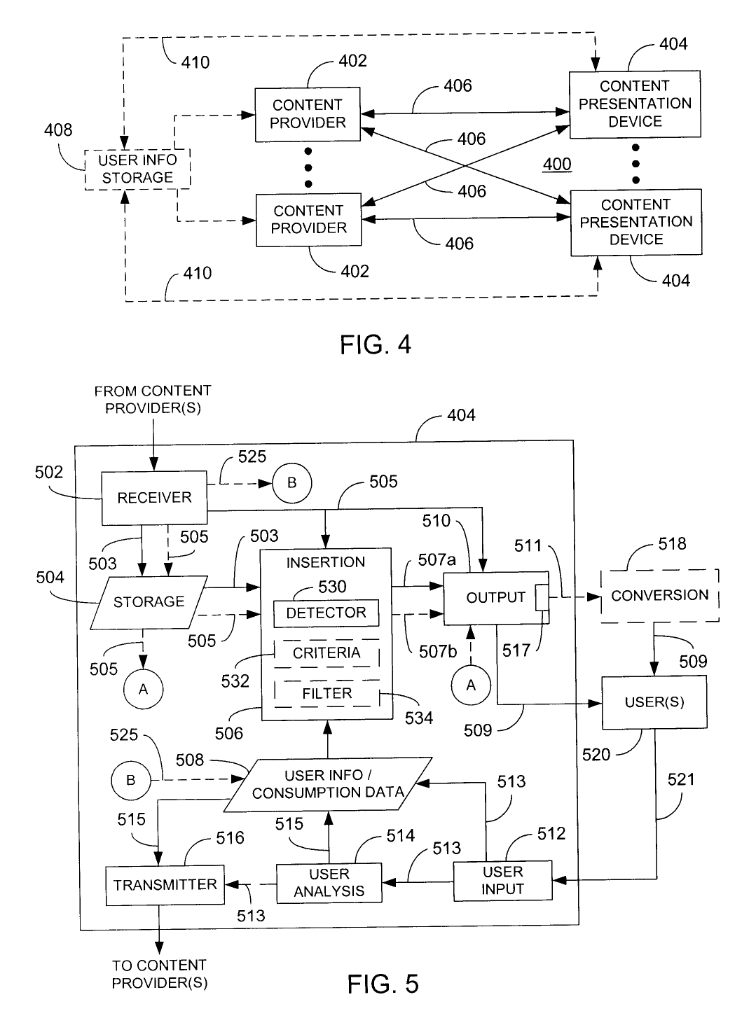

Referring now to FIG. 4, a communication system 400 is illustrated and comprises one or more content providers 402 in communication with a plurality of content presentation devices 404. Generally, any given content provider 402 may provide programming content and/or auxiliary content 406 to any of the content presentation devices 404. As used herein, a content provider 402 may comprise any source of programming and/or auxiliary content, which programming and/or auxiliary content is delivered in any convenient manner. Such content providers may be generally viewed as falling into one or more of three different categories. For example, a programming content provider may be any one of many primary content creation and production houses (e.g., Warner Brothers, Paramount, Electronic Arts, a cable television network, etc.). An auxiliary content provider may be any one of many advertising, promotional, public service, information management, or other branding creation and production houses known to those of skill in the art. Further still, a content provider may comprise a service provider that operates the network (or portions thereof) or network sources used to provide the programming content and/or auxiliary content to the content presentation devices 404. For example, a service provider may comprise a local cable provider, an internet provider or other entity communicating directly with the content presentation devices 404. Alternatively, the service provider may be further upstream relative to the content presentation devices, such as a regional or national service provider. It will be further appreciated that the content provider 402 may comprise more than one of these categories of content providers. For example, a local cable provider may relay normal programming content received from upstream providers, but also provide its own auxiliary content for insertion into such programming content.

As described in greater detail below, each content presentation device may provide user information directly back to the one or more content providers 402 or, as further shown, may optionally provide the user information 410 to a user information database 408. Although illustrated as a centralized database that is external relative to the content providers 402, it is understood that, in practice, the database 408 could be distributed across several such databases, the entirety or portions of which distributed databases could be incorporated into one or more of the content providers 402. In the event that the user information database 408 is provided, it may be in direct communication with the content providers 402, thereby allowing the user information 410 to be incorporated into the determination of the programming content and/or auxiliary content to be sent to the content presentation devices 404. The user information may also be provided by the content presentation device 404 directly to and stored by one or more of the content providers 402 for the same purpose. Further still, the user information may be provided by either the content providers 404 or user information database 408 back to the content presentation devices 404. This may be the case, for example, where a given user moves between different content presentation devices, either or both of which do not normally have the user's information stored locally, or where a single device is used to support multiple user profiles.

Referring now to FIG. 5, a content presentation device 404, in accordance with an embodiment, is illustrated in greater detail. The content presentation device 402 is embodied in a device or devices comprising one or more processors, such as a microprocessor, microcontroller, digital signal processor, etc. and executable instructions, stored in suitable storage devices coupled to the one or more processors, that may be executed by the one or more processors. Alternatively, the content presentation device 404 may comprise various hardware and/or firmware components that implement various portions of the functionality illustrated in FIG. 5 and described herein. Such hardware/firmware components may be implemented using well known techniques such as application specific integrated circuits, programmable logic arrays, discrete logic circuits, etc. Those having ordinary skill in the art will appreciate that a variety of such implementations are available and the present invention is not limited in this regard.

In an embodiment, the content presentation device 404 comprises a receiver 502 in communication with a storage device 504. The receiver 502 may comprise any type of circuitry and/or logic necessary to receive content provided by the one or more content providers 402. For example, the receiver 502 may comprise suitable radio frequency (RF) de-modulation and baseband extraction circuitry and software in the case where the one or more content providers 402 communicate with the content presentation device 404 via an intervening wireless or cable television network. Alternatively, the receiver 502 may comprise circuitry and/or software necessary to terminate a computer network communication channel implementing suitable communication protocols, e.g., the so-called Transmission Control Protocol/Internet Protocol (TCP/IP) suite. Still other suitable communication channels, and corresponding receivers 502, will be readily apparent to those of ordinary skill in the art. The storage device 504 may comprise any suitable storage device such as volatile or non-volatile memory including, but not limited to, random access memory (RAM), electrically-erasable programmable read-only memory (EEPROM), etc. Although not shown in FIG. 5, the functionality embodied by the receiver 502 and storage device 504 may be replaced by one or more suitable media reading devices such as typical media reader, magnetic media reader, or other similar readers. Thus, for example, the programming and/or auxiliary content may be input to the content presentation device 404 via a suitable, removable storage medium, such as so-called floppy disks, compact disks, thumb drives, etc. In these instances, the content provider may comprise the entity responsible for providing the removable storage medium to the user.

As shown, the receiver 502 provides auxiliary content 503 received from the one or more content providers to the storage device 504. Additionally, the receiver 502 provides the programming content 505 to one or more of an insertion component 506 and an output component 510. Alternatively or additionally, as shown, the receiver 502 may provide the programming content 505 to the storage device 504 as in the case, for example, of a digital video recorder (DVR). In this embodiment, the storage device 504 can subsequently provide the programming content 505 directly to the output component 510. Thus, the auxiliary content 503 may be stored, regardless of how it is received, whereas the programming content 505 may be either used substantially in real-time, i.e., as it is received without regard to any potential short term buffering (less than the duration of the programming content being received), or placed in long term storage for subsequent use.

As shown, the insertion component 506 is in communication with the receiver 502, storage device 504, and the output component 510. Generally, the insertion component 506 is responsible for inserting at least a portion of the auxiliary content 503 into the received programming content 505. To this end, the insertion component 506 comprises a plurality of subcomponents, including a detector component 530, an insertion criteria storage component 532 and a filtering component 534. The detector component 530 operates to detect the detectible indicia present in the programming content 505. For example, the detector component 530 can detect one or more DTFM tones or digitally-represented messages present in the programming content 505 used to delimit suitable time slots within the programming content 505. As noted above, various devices capable of performing such detection are well known in the art, which functionality may be incorporated into the content presentation device 404, specifically the detector component 530. Regardless of the particular detection technique used, the detectable indicia included in the programming content is typically added to the programming content after authoring or production of the programming content. In a more sophisticated embodiment, the detector 530 may operate to recognize the occurrence of certain integral features, characteristics or elements inherent in the programming content 505 itself. For example, using audio and/or image recognition technology, the detector 530 can recognize the occurrence of certain words or phrases, or various images within the programming content 505, i.e., detectable indicia. Regardless of the manner in which it is implemented, the detector component 530 allows the content presentation device 404 to determine when it is proper to insert at least a portion of the auxiliary content 503 into the programming content 505.

In an embodiment, the auxiliary content 503 to be inserted into the programming content 505 may be selected for insertion in accordance with insertion criteria and/or filtered in accordance with user information. As used herein, the user information may comprise specific demographics concerning users of a given content presentation device 404 such as age, gender, residential address, occupation, etc. Additionally, the user information may comprise preference information that is explicitly provided by the one or more user or that may be inferred from various data obtained from the users. For example, the preference information may include, but is not limited to, indications of various likes and dislikes of a given user (or groups of users), indications of what types of auxiliary content the user(s) never/always want presented, consumption habits such as frequently consumed programming content by specific name or genre, etc. Based on the user information, the insertion component 506 may determine what types of auxiliary content are to be inserted into the programming content 505 by comparing the user information to the available, locally-stored auxiliary content. To this end, in an embodiment, the auxiliary content may include at least some metadata descriptive of the auxiliary content, which metadata may be employed to effect comparisons between the user information and the metadata when selecting particular auxiliary content for presentation. By way of a non-limiting example, a given component of auxiliary content, such as an advertisement, may include metadata that describes what specific topics or things are depicted therein, the duration of the auxiliary content, the source of the auxiliary content, any suggested viewing restrictions, target viewer demographics, etc. In a similar vein, the programming content may include similar metadata such that comparisons between the programming content and the auxiliary content may be effected, thereby allowing a determination of the relative compatibility of the programming and auxiliary content. For example, during professional sporting events programming, it may be more desirable to include advertisements concerning automobiles rather than child care products, given the demographics of the likely consumers of such content.

The insertion criteria stored in the criteria storage component 532, in contrast, can be used to determine specifically when certain types of auxiliary content (which may or may not be filtered according to the filter criteria 534) are actually inserted within the programming content 505. For example, the insertion criteria may comprise, but is not limited to, expiration dates of particular portions of the auxiliary content 503, an indication of a preferred time of day for inserting a specific portion of the auxiliary content 503, formats of the programming content 505 and the auxiliary content 503 (High Definition vs. Standard Definition), allowed V-Chip or parental guidance ratings for programming content 505, etc. Using such insertion criteria, the insertion component 506 may compare the metadata included with the auxiliary content against the insertion criteria to determine those portions of the auxiliary content that are eligible for insertion into the programming content.

The user information described above may be stored in a suitable storage device 508 (e.g., volatile and/or non-volatile memory) that is in communication with the insertion component 506. Additionally, the storage component 508 may include user information 515 provided by a user analysis component 514. In turn, the user analysis component 514 is coupled to a user input component 512 that receives user input 521 from one or more users 520. The user input component 512, which may comprise a keypad, remote controller receiver or similar device, receives various data such as channel selection data, video on demand order information, programming guide selections, recording instructions, etc. The user input 521 received by the user input output component 512 may be provided as input representative of consumption data 513 to the storage component 508. Conversely, the input 513 may be provided to the user analysis component 514 where it is operated upon to derive the user information 515. That is, in one embodiment, metadata of the viewed programming is analyzed to infer genre preferences about the user, which can then be compared to other user preference profiles to infer a probable demographic profile and/or set of viewer interests. For example, to the extent that the input representative of the consumption data 513 indicates that a particular user enjoys watching sports programming via his cable television network connection, the user analysis component 514 can make note of this and designate sports programming as a preference of that user. In yet another embodiment, the user information may be received from one or more of the content providers via the receiver 502, which user information 525 is thereafter provided to the storage component 508. Regardless of the manner in which it is received, the user information may be provided to the insertion component 506 for use, as described above, in selecting which of the auxiliary content 503 should be inserted into the programming content 505. Further still, as shown, the storage component 508 may be coupled to a transmitter component 516 configured to communicate with the one or more content providers 402, or with the user information database 408. That is, like the receiver component 502, the transmitter component 516 may implement one or more suitable communication protocols used to communicate with the content providers 402 and/or the user information database 408. Using the transmitter component 516, the input representative of the consumption data 513 received from the user analysis block 514 may be transmitted to the content providers 402, or the user information 515 stored in the storage component 508 may likewise be provided to the content providers 402.

As described above, the insertion component 506 operates to select at least a portion of the auxiliary content 503 for insertion into the programming content 505. The output component 510 may be in communication with the insertion component 506 and/or the receiver component 502 as illustrated. The output component 510 operates to output the programming content 505, 507b and the filtered portion of the auxiliary content 507a. As illustrated, the output component 510 may receive the programming content directly from the receiver 502, from the insertion component 506, or from the storage component 504. Depending on the nature of the content presentation device 404, the output component 510 may be in communication with a conversion component 518 via an output interface 517. The output interface 517, when provided, is used to implement the necessary communication protocol, if any, or to provide the necessary format for communication with the conversion component 518. For example, where the content presentation device 404 is not responsible for rendering the programming content 505, 507b or the auxiliary content 507a into human perceptible format (as in the case, for example, of a cable set top box), the programming content and auxiliary content 511 may be provided to the conversion component 518, which in this example may comprise a suitable television or other device, for conversion to a human perceptible format 509. In the example of a cable set top box communicating with a television, the output interface 517 may comprise any logic and/or circuitry necessary to modulate the programming and auxiliary content onto a suitable channel (e.g. a Radio Frequency (RF) channel). Alternatively, in the case where the content presentation device 404 is directly responsible for rendering the programming content 505, 507b and the auxiliary content 507a into human perceptible format, the output component 510 may interface directly with the users, providing the users 520 with the human perceptible format 509, e.g., a laptop computer having an integral display device, or a portable media player with integrated audio/visual components.

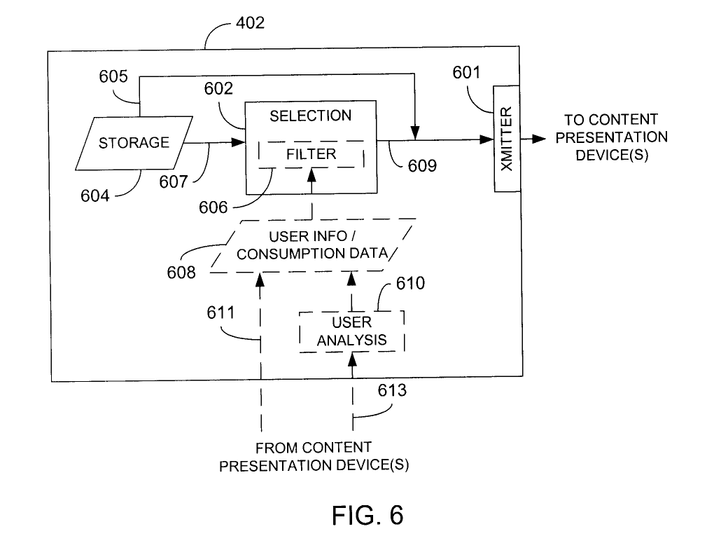

Referring now to FIG. 6, a content provider 402 is illustrated in greater detail. In an embodiment, the content provider 402 is embodied, at least in part, by a device or devices comprising one or more processors, such as a microprocessor, microcontroller, digital signal processor, etc. and executable instructions, stored in suitable storage devices coupled to the one or more processors, that may be executed by the one or more processors. Alternatively, the content provider 402 may comprise various hardware and/or firmware components that implement various portions of the functionality illustrated in FIG. 6 and described herein. Such hardware/firmware components may be implemented using well known techniques such as application specific integrated circuits, programmable logic arrays, discrete logic circuits, etc. For example, the content provider 402 may be embodied by one or more suitably configured server computers in communication with one or more database servers. Those having ordinary skill in the art will appreciate that a variety of such implementations are available and the present invention is not limited in this regard.

As shown, the content provider 402 may comprise a transmitter component 601 in communication with a selection component 602 and a storage component 604. The transmitter component 601 implements any communication protocol necessary to communicate with the receiver components 502 of the various content presentation devices 404. The transmitter component 601 can receive programming content or auxiliary content directly from the storage component 604, or it can receive the auxiliary content 609 from the selection component 602. As shown, the selection component 602 comprises a filter component 606 that operates upon the available auxiliary content 607 stored in the storage component 604 based on the user information or consumption data 608 stored in a suitable storage component. In this instance, the filter component 606 uses the information/consumption data 608 to select which of the available auxiliary content 607 would be best provided to the user of a given content presentation device. To this end, the user information 611 may be received directly from the user information storage component 408, if provided. Additionally, a user analysis component 610 may be provided that receives user input representative of consumption data 613 from either the content presentation device 404 or the user information database 408. (Note that a receiver component, not shown, similar to the receiver component 502 illustrated in FIG. 5, may be provided as part of the content provider 402 and act as an interface, for example, between the user analysis component 610 and/or the user information/consumption data storage component 608 and the content presentation device 404 and/or the user information database 408.) Using techniques similar to those described above, the user analysis component 610 may also derive the desired user information. As noted above, the content provider 402 may be dedicated solely to one type of content versus another, e.g., operating solely as a programming content provider or as an auxiliary content provider, or both.

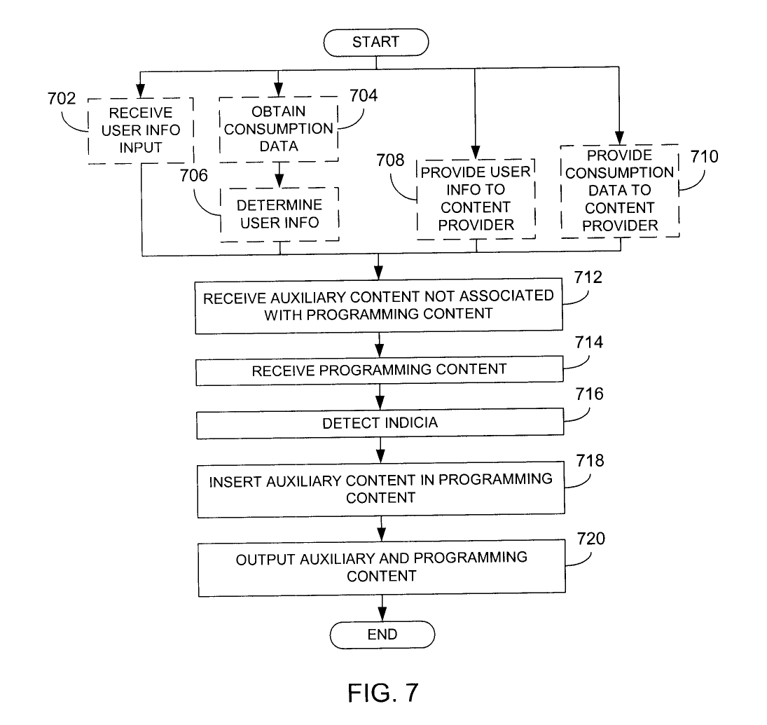

Referring now to FIG. 7, a flow chart illustrating operation of a content presentation device, such as those described above, is further illustrated. At block 702, the content presentation device may optionally receive user information input of the type described above. That is, the user can provide various demographic data, preference data, etc. relevant to operation of the content presentation device as described above. Alternatively, at block 704, the content presentation device may optionally obtain consumption data in the form of user inputs. Thereafter, at block 706, the user information may be derived based on the consumption data. Further still, at either blocks 708 or 710, the content presentation device may optionally provide user information or consumption data to the content provider. Further still, where a user information database 408 is provided, the operation of block 708 and 710 may be modified to provide the user information and/or consumption data directly to the user information database 408.

Regardless of how the user information and/or consumption data is obtained or to whom it is provided, processing continues at block 712 where auxiliary content, not associated with any particular programming content, is received. The received auxiliary content may come from one or more content providers. As used herein, the auxiliary content not being associated with any particular programming content refers to a lack of temporal alignment of the auxiliary content relative to any programming content. That is, the auxiliary content need not be provided at the same time as the programming content in which it will eventually be provided, although this is possible. However, the auxiliary content may actually be related to the programming content in which it is eventually provided in a topical or thematic sense. Receipt of the auxiliary content may be in response to a prior request from the content presentation device or another device acting as its proxy (i.e., a “pull” model), or may be automatically provided by the content provider(s) without prior request (i.e., a “push” model).

Continuing at block 714, the content presentation device subsequently receives programming content. Note that the programming content may be received from a content provider that is identical to the content provider that provided the auxiliary content, or the programming content provider may be different from the auxiliary content provider. Once again, either a push and/or pull model for content delivery may be employed in conjunction with delivery of the programming content. Processing thereafter continues at block 716 where one or more detectible indicators within the programming content are detected by the content presentation device. Thereafter, at block 718, at least a portion of the auxiliary content is inserted into the programming content based on the detected indicator. As noted above, the inserted auxiliary content may be provided in accordance with user information to more precisely target the auxiliary content to the particular preferences and/or desires of the user of the content presentation device. Further still, the portion of the auxiliary content to be inserted into the programming content may also be selected based on the insertion criteria stored by the content presentation device. Note that the insertion of the auxiliary content into the programming content need not occur at the time the programming content is being output for consumption by the user. That is, the insertion can take place prior to consumption by the user in the case where the programming content is available in long term storage to the content presentation device. In this scenario, the stored programming content could be modified to either have the auxiliary content actually added in-line to the programming content or to have redirection pointers instructing the output component where to go get the inserted auxiliary content during output of the programming content, followed by another redirection pointer back to the programming content.

Continuing at block 720, the programming content and inserted auxiliary content may be output by the content presentation device. As noted above, the nature in which the content presentation device outputs the programming content and inserted auxiliary content depends on the particular capabilities of the content presentation device. That is, in the case where the content presentation device is responsible for rendering the content into human perceptible format, the output operations performed by the content presentation device include first converting the content into human-perceptible format. Conversely, if the content presentation device is not responsible for rendering the content into human-perceptible format, output of the contents may comprise simply providing the programming content and inserted auxiliary content to an appropriate conversion device, as described above.

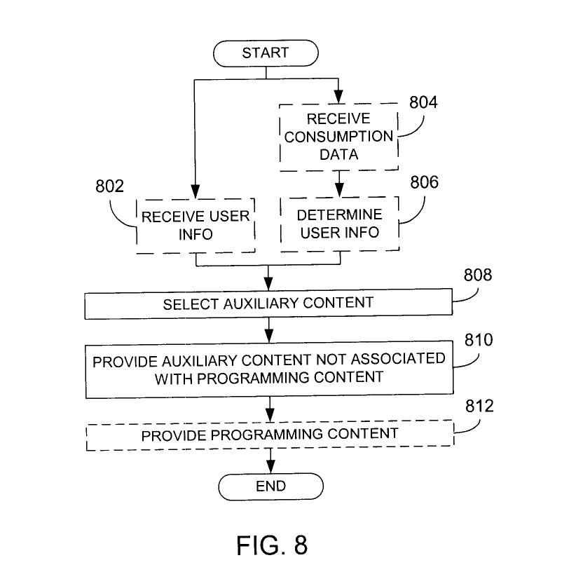

Referring now to FIG. 8, processing in accordance with a content provider is further illustrated. As illustrated, various optional blocks 802-806 are illustrated. In particular, at block 802, the content provider may receive user information from a given content presentation device or user information database as described above. Alternatively, the content provider may receive consumption data at block 804 directly from the content presentation device or, once again, from the user information database. In the case of received consumption data, processing continues at block 806 where the received consumption data may be analyzed to derive the desired user information, as described previously. Regardless, processing continues at block 808 where that portion of the available auxiliary content to be provided to the content presentation device is selected. As noted above, the portion of the available auxiliary content to be sent to the content presentation device may be selected based on user information specific to the one or more content presentation devices. Alternatively, or additionally, the auxiliary content to be provided may be selected based on pre-arranged scheduling, as known in the art.

Thereafter, the selected portion of the auxiliary content selected is provided to the content presentation device(s) at block 810. Note that, as described above, the auxiliary content provided at block 810 is not associated with any particular programming content. For example, the auxiliary content provided at block 810 may be provided to the content device(s) at a time when there is likely to be unused network and device processing capacity, e.g., in the late evening hours. Alternatively, an additional or auxiliary channel between the content provider and the content presentation device may be used to transmit the auxiliary content at any time. For example, in the case of broadcast or cable television, suitable sub-channels (such as during a blanking interval) may be employed. Finally, processing may optionally continue at block 812 where programming content, as described above, is also provided by the content provider to the content presentation device.

As described above, the instant disclosure describes various techniques for the presentation of auxiliary content via a content presentation device. Taking advantage of the availability of large amounts of storage in content presentation devices, the auxiliary content may be provided to a content presentation device without being associated with any particular programming content. Subsequent to receipt of the auxiliary content, programming content may be received. By detecting the occurrence of detectible indicia in the programming content, portions of the auxiliary content may be inserted into the programming content by the content presentation device. Because the content presentation device is responsible for inserting the auxiliary content in the programming content, the auxiliary content can be much more targeted to a specific user of the content presentation device than would have been possible using prior art techniques. For at least these reasons, the above-described techniques represent an advancement over prior art teachings.

While particular preferred embodiments have been shown and described, it will be obvious to those skilled in the art that changes and modifications may be made without departing from the instant teachings. It is therefore contemplated that any and all modifications, variations or equivalents of the above-described teachings fall within the scope of the basic underlying principles disclosed above and claimed herein.

What is claimed is:

1. In a communication system comprising a plurality of content presentation devices in communication with at least one content provider, a method in a content presentation device of the plurality of content presentation devices comprising:
receiving auxiliary content not associated with any programming content from the at least one content provider;
receiving programming content comprising detectable indicia from the at least one content provider;
detecting at least one of the detectable indicia in the programming content; and
upon detection of the at least one of the detectable indicia, inserting at least a portion of the auxiliary content into the programming content.

2. The method of claim 1, further comprising receiving the programming content and the auxiliary content from a first content provider of the at least one content provider.

3. The method of claim 1, further comprising receiving the programming content from a first content provider of the at least one content provider and the auxiliary content from a second content provider of the at least one content provider.

4. The method of claim 1, wherein inserting the portion of the auxiliary content further comprises:
filtering the auxiliary content according to user information of at least one user of the content presentation device to provide filtered auxiliary content; and
inserting at least a portion of the filtered auxiliary content during output of the programming content.

5. The method of claim 1, wherein inserting the portion of the auxiliary content further comprises:
selecting the portion of the auxiliary content based on insertion criteria.

6. The method of claim 1, further comprising:
outputting the programming content and the portion of the auxiliary content for presentation to at least one user of the content presentation device.

7. In a communication system comprising a plurality of content presentation devices in communication with at least one content provider, a method comprising:
selecting, by a content provider of the at least one content provider, auxiliary content configured for insertion into, but not associated with, any programming content;
providing, by the content provider, the auxiliary content to at least one content presentation device of the plurality of content presentation devices; and
providing, by the content provider to the at least one content presentation device, programming content capable of being output by the at least one content presentation device with at least a portion of the auxiliary content inserted in the programming content.

8. The method of claim 7, wherein selecting the auxiliary content further comprises filtering available auxiliary content according to user information of at least one user of a content presentation device of the plurality of content presentation devices to provide the auxiliary content.

9. A content presentation device, comprising:
at least one processor; and
at least one storage device, in communication with the at least one processor, having stored thereon instructions that, when executed by the at least one processor, cause the at least one processor to:
receive auxiliary content not associated with any programming content from at least one content provider;
receive programming content comprising detectable indicia from the at least one content provider;
detect at least one of the detectable indicia in the programming content; and
upon detection of the at least one of the detectable indicia, insert at least a portion of the auxiliary content into the programming content.

10. The content presentation device of claim 9, the at least one storage device further comprising instruction that, when executed by the at least one processor, cause the at least one processor to:
filter the auxiliary content according to user information of at least one user of the content presentation device to provide filtered auxiliary content; and
insert at least a portion of the filtered auxiliary content during output of the programming content.

11. The content presentation device of claim 9, wherein the instructions that, when executed by the at least one processor, cause the at least one processor to insert the portion of the auxiliary content further comprise instructions that, when executed by the at least one processor, cause the at least one processor to:
select the portion of the auxiliary content based on insertion criteria.

12. The content presentation device of claim 9, the at least one storage device further comprising instruction that, when executed by the at least one processor, cause the at least one processor to:
output the programming content and the portion of the auxiliary content for presentation to at least one user of the content presentation device.

13. A content presentation device, comprising:
a receiver component operative to receive, from any of at least one content provider, auxiliary content not associated with any programming content and to receive, from any of the at least one content provider, programming content;
a storage component, in communication with the receiver component, operative to store the auxiliary content;
an insertion component, in communication with the storage component, operative to insert at least a portion of the auxiliary content into the programming content; and
an output component, in communication with the insertion component, operative to output the programming content and the portion of the auxiliary content for presentation to at least one user of the content presentation device.

14. The content presentation device of claim 13, wherein the output component receives the programming content and the portion of the auxiliary content from the insertion component.

15. The content presentation device of claim 13, wherein the output component is in communication with the receiver component and receives the programming content from the receiver component.

16. The content presentation device of claim 13, wherein the storage component is further operative to store the programming content, and wherein the output component is in communication with the storage component and receives the programming content from the storage component.

17. The content presentation device of claim 13, wherein the insertion component is further operative to filter the auxiliary content according to user information of at least one user of the content presentation device to provide filtered auxiliary content and to insert at least a portion of the filtered auxiliary content into the programming content.

18. The content presentation device of claim 13, wherein the insertion component is further operative to select the portion of the auxiliary content based on insertion criteria.

19. The content presentation device of claim 13, wherein the programming content comprises detectable indicia, and wherein the insertion component is further operative to insert the portion of the auxiliary content into the at least one advertising time slot based on detection of the detectable indicia.

20. The content presentation device of claim 13, wherein the output component comprises an output interface operative to provide the programming content and the portion of the auxiliary content to a conversion component operative to render the programming content and the portion of the auxiliary content into human-perceptible form.

21. The content presentation device of claim 13, wherein the output component is operative to render the programming content and the portion of the auxiliary content into human-perceptible form.

22. A communication system comprising:
at least one content provider that provides programming content and auxiliary content not associated with any programming content; and
a plurality of content presentation devices in communication with the at least one content provider, at least one content presentation device of the plurality of content presentation devices operable to receive the programming content and the auxiliary content from the at least one content provider and to insert at least a portion of the auxiliary content into the programming content.

23. The communication system of claim 22, further comprising a first content provider of the at least one content provider that provides the programming content and the auxiliary content.

24. The communication system of claim 22, further comprising a first content provider of the at least one content provider that provides the programming content and a second content provider of the at least one content provider that provides the auxiliary content.

25. The communication system of claim 22, further comprising:
a user information database in communication with the at least one content provider and the plurality of content presentation devices and operative to store user information of users of the plurality of content presentation devices, wherein filtering of the auxiliary content is performed by at least one of the at least one content provider or the plurality of content presentation devices.

26. A computer-readable medium comprising executable instructions that, when executed, cause at least one processor to:
receive, via a content presentation device in communication with at least one content provider, auxiliary content not associated with any programming content from the at least one content provider;
receive, via the content presentation device, programming content comprising detectable indicia from the at least one content provider;
detect at least one of the detectable indicia in the programming content; and
upon detection of the at least one of the detectable indicia, insert at least a portion of the auxiliary content into the programming content.

27. The computer-readable medium of claim 26, further comprising executable instructions that, when executed, cause the at least one processor to receive, via the content presentation device, the programming content and the auxiliary content from a first content provider of the at least one content provider.

28. The computer-readable medium of claim 26, further comprising executable instructions that, when executed, cause the at least one processor to receive, via the content presentation device, the programming content from a first content provider of the at least one content provider and the auxiliary content from a second content provider of the at least one content provider.

29. The computer-readable medium of claim 26, further comprising executable instructions that, when executed, cause the at least one processor to:
filter the auxiliary content according to user information of at least one user of the content presentation device to provide filtered auxiliary content; and
insert at least a portion of the filtered auxiliary content during output of the programming content.

30. The computer-readable medium of claim 26, further comprising executable instructions that, when executed, cause the at least one processor to:
select the portion of the auxiliary content based on insertion criteria.

31. The computer-readable medium of claim 26, further comprising executable instructions that, when executed, cause the at least one processor to:
output the programming content and the portion of the auxiliary content for presentation to at least one user of the content presentation device.

32. A computer-readable medium comprising executable instructions that, when executed, cause at least one processor to:
select auxiliary content configured for insertion into, but not associated with, any programming content;
provide the auxiliary content to at least one content presentation device of a plurality of content presentation devices; and
provide programming content capable of being output by the at least one content presentation device with at least a portion of the auxiliary content inserted in the programming content.

33. The computer-readable medium of claim 32, further comprising executable instructions that, when executed, cause the at least one processor to, when selecting the auxiliary content, filter available auxiliary content according to user information of at least one user of a content presentation device of the plurality of content presentation devices to provide the auxiliary content.
